(19) United States
(12) Patent Application Publication
(10) Pub. No.: US 2026/0271140 A1
(43) Pub. Date: Sep. 10, 2026

(54) INDUCTION COOKTOP DEVICE

(71) Applicant: BSH Hausgeäte GmbH, Munich (DE)

(72) Inventors: Paul Muresan, La Cartuja (ES); Diego Puyal Puente, Zaragoza (ES); Nicolas Blasco Rueda, Zaragoza (ES); Javier Serrano Trullen, Zaragoza (ES); Jorge Gaston Puig, Zaragoza (ES); Arturo Acevedo Simon, Zaragoza (ES); Miguel Ángel Pradas López, Zaragoza (ES); Jorge Español Leza, Zaragoza (ES)

(21) Appl. No.: 19/162,974

(22) PCT Filed: Apr. 17, 2024
(86) PCT No.: PCT/EP2024/060402

§ 371 Date: Sep. 8, 2025

(30) Foreign Application Priority Data
Apr. 19, 2023 (EP) 23382359.0

(51) Int. Cl. H05B 6/06; H05B 6/12

(52) U.S. Cl. CPC H05B 6/062; H05B 6/1209

(57) ABSTRACT

An induction cooktop device comprising at least one heating inductor and at least one detection unit which has at least one self-oscillating oscillator circuit, which is intended to measure properties of an induction load of the heating inductor, and has a feedback network, wherein the heating inductor is part of the feedback network, and comprising a scanning unit for scanning an output signal of the detection unit at a measurement output of the oscillator circuit. In order to improve ease of use, the invention proposes that the scanning unit is provided to determine a frequency and an amplitude of the output signal.

The invention relates to an induction cooktop apparatus according to the preamble of claim 1 and a method for operating an induction cooktop apparatus according to the preamble of claim 15.

Induction cooktops with heating inductors and a detection unit for measuring properties of an induction load of a heating inductor, for example for pot detection, are already known from the prior art. In many cases, the heating inductors are used as sensors, wherein in a detection mode, one of the heating inductors is part of a feedback network of a self-oscillating oscillator circuit of the detection unit, which, for example, can be designed as a Colpitts oscillator. In detection mode, the heating inductor is supplied with a high-frequency detection signal the frequency of which depends on the properties of an induction load of the heating inductor. The frequency can then be used to infer a presence of an item of cookware above the heating inductor and to determine the degree of coverage between the item of cookware and the heating inductor. However, such measurements of the properties of the induction load, which are based solely on the frequency of an output signal of the detection unit, are relatively inaccurate, and some properties, such as a material of an item of cookware used, cannot yet be determined accurately with previously known induction cooktop apparatuses based on this method, which disadvantageously severely limits operating convenience for users.

The object of the invention is in particular, but not limited thereto, to provide a generic apparatus with improved properties with respect to operating convenience. The object is achieved in accordance with the invention by the features of claims 1 and 15, while advantageous embodiments and developments of the invention can be derived from the subordinate claims.

The invention relates to an induction cooktop apparatus with at least one heating inductor and at least one detection unit, which has at least one self-oscillating oscillator circuit that is designed to measure properties of an induction load of the heating inductor, and a feedback network, wherein the heating inductor is part of the feedback network, and with a scanning unit for scanning an output signal of the detection unit at a measurement output of the oscillator circuit.

It is proposed that the scanning unit is designed to determine a frequency and amplitude of the output signal.

Such a design can provide an induction cooktop apparatus with improved properties with respect to operating convenience. Determining the frequency and amplitude improves the ability to distinguish more accurately between cookware materials, in particular between non-ferromagnetic and ferromagnetic materials. Determining the amplitude of the output signal as a second dimension in addition to the frequency opens up the particularly advantageous possibility of identifying certain types of materials that could not be identified with previously known induction cooktop apparatuses. This advantageously provides a user of an induction cooktop equipped with the induction cooktop apparatus with improved feedback on the quality of the cookware in terms of its suitability for use with the induction cooktop, as a result of which it is possible to improve operating convenience and user-friendliness. Furthermore, non-ferromagnetic materials such as aluminum cannot be heated with current induction technology, and cookware made of such materials is currently detected using an approach in which the inverters are used for detection, which generates noises that can be disturbing to users. If, on the other hand, a scanning unit is provided to determine the frequency and amplitude of the output signal, it is also advantageous to enable the detection of non-ferromagnetic materials without generating noise, thereby further improving operating convenience.

The induction cooktop apparatus is designed as a part, in particular as a sub-assembly, of an induction cooktop. The induction cooktop apparatus may also comprise the entire induction cooktop. The induction cooktop apparatus comprises at least one heating inductor which, in the heating mode, supplies energy in the form of an alternating electromagnetic field to at least one object, in particular to an item of cookware. The induction cooktop apparatus could have at least two, in particular at least three, advantageously at least four, particularly advantageously at least five, preferably at least eight and particularly preferably multiple heating inductors, which in the heating mode can each supply energy inductively, in particular to a single object or to at least two or more objects. At least some of the heating inductors could be arranged in close proximity to one another, for example in series and/or in the form of a matrix. The induction cooktop apparatus can have an inverter unit with at least two inverter switching elements for supplying energy to the at least one heating inductor. Alternatively, the inverter unit can also be part of an induction cooktop that has the induction cooktop apparatus. The inverter switching elements of the inverter unit can be designed as semiconductor switching elements, in particular as transistors, for example as metal oxide semiconductor field effect transistors (MOSFET) or organic field effect transistors (OFET), advantageously as bipolar transistors with preferably insulated gate electrodes (IGBT).

The detection unit is designed to measure properties of an induction load of the heating inductor, for example, and without being limited thereto, for detecting the presence of an object, in particular an item of cookware or a metallic foreign object, above the heating inductor and/or for measuring a degree of coverage of the heating inductor by the object and/or for measuring material properties of the object and/or the like. The induction load of the heating inductor can be characterized by the substitute inductance and the substitute electrical resistance of the heating inductor, wherein the substitute inductance and the substitute electrical resistance of the heating inductor depend on the presence of a metal object, for example an item of cookware, above the heating inductor and on the shape, size, position, and material of the object. The detection unit has the self-oscillating oscillator circuit, which is provided to measure the properties of the induction load of the heating inductor in a detection mode. The self-oscillating oscillator circuit can be designed, for example, as a Colpitts oscillator, preferably as a Clapp oscillator. The self-oscillating oscillator circuit is designed to generate a detection signal in the detection mode and to apply the detection signal to the heating inductor, wherein the heating inductor is part of the feedback network of the self-oscillating oscillator circuit. The self-oscillating oscillator circuit is provided to supply the heating inductor in detection mode with a high-frequency detection signal, in particular with a frequency between 50 kHz and 100 MHz, preferably with a frequency of at least 0.8 MHz and at most 2 MHz. Since the heating inductor is part of the feedback network of the self-oscillating oscillator circuit, the induction load of the heating inductor influences the frequency and amplitude of the output signal, which can be tapped at the measurement output of the self-oscillating oscillator circuit by the scanning unit.

The scanning unit is designed to scan the output signal of the detection unit at the measurement output of the oscillator circuit and has corresponding units and/or elements for determining the frequency and amplitude of the output signal. Units and/or elements of the scanning unit for determining the frequency and amplitude of the output signal could, for example and without being limited thereto, comprise measuring transducers and/or amplifiers and/or shunt resistors and/or an oscilloscope and/or the like. Preferably, all units of the scanning unit are arranged on a common circuit board.

In the present document, numerals such as “first” and “second” preceding certain terms serve only to distinguish objects and/or to assign objects to one another and do not imply any existing total number and/or ranking of the objects. In particular, a “second object” does not necessarily imply the existence of a “first object.”

The term “provided” is to be understood to mean especially programmed, designed and/or equipped. The expression that an object is provided for a specific function is to be understood in particular to mean that the object fulfills and/or performs this specific function in at least one application state and/or operating state.

It is also proposed that the scanning unit has a computing unit which is provided to evaluate the frequency and amplitude of the output signal in order to determine the properties of the induction load of the heating inductor by means of at least one algorithm. This has the advantage of further improving operating convenience. In particular, a range of information about an item of cookware used can be determined and output to users if the scanning unit comprises the computing unit, which is designed to evaluate the frequency and amplitude of the output signal in order to determine the properties of the induction load of the heating inductor by means of at least one algorithm. For this purpose, the computing unit is preferably designed to be connected to a control and/or output unit of an induction cooktop having the induction cooktop apparatus. A “computing unit” is understood to mean a unit with at least one input, information processing, and at least one output. Advantageously, the computing unit has at least one processor, a working memory, input and output means, further electrical components, and at least one operating program for executing the at least one algorithm. The components of the computing unit are preferably arranged on a common circuit board, preferably on the circuit board of the scanning unit. The computing unit is preferably designed as a microcontroller.

It is also proposed that the computing unit has a memory unit in which reference values of frequencies and amplitudes of reference output signals for different induction loads are stored, and that the computing unit is designed to compare the frequency and amplitude of the output signal with the reference values during evaluation. Such a design has the advantage of improving the accuracy of the evaluation and thus further increasing operating convenience. The memory unit is preferably designed to store the reference values of the frequencies and amplitudes of the reference output signals permanently for different induction loads and, in particular, independently of a power supply.

Furthermore, it is proposed that the algorithm be self-learning. This has the advantage of further improving the accuracy of the evaluation and thus further increasing operating convenience. The computing unit can, for example, be designed to store frequencies and amplitudes of output signals detected in previous detection processes in the memory unit, feed them into the self-learning algorithm, and use them when evaluating a current output signal. It is also conceivable that the self-learning algorithm is provided to optimize individual or all reference values of frequencies and amplitudes of the reference output signals for different induction loads stored in the memory unit on the basis of frequencies and amplitudes of output signals detected in previous detection processes. It is also conceivable that users can enter information about an item of cookware used, such as a shape and/or size and/or material of the item of cookware, via a user interface of the induction cooktop apparatus and/or an item of cookware comprising the induction cooktop apparatus, and that the self-learning algorithm is provided to use this information for future evaluations. The self-learning algorithm can be used, for example, to standardize the size of an item of cookware, since the output signal of the detection unit can have different frequency values depending on the type of material of the item of cookware with the same pot diameter, which can be standardized by including the amplitude.

It is further proposed that the scanning unit comprises a converter unit which is connected to the measurement output of the oscillator circuit and is designed to convert the output signal into a square wave signal for determining the frequency. Such a design has the advantage of enabling the frequency of the output signal of the detection unit to be determined using particularly simple technical means and in a particularly cost-effective manner. The converter unit comprises an input connected to the measurement output of the oscillator circuit. The converter unit preferably comprises an output connected to an input of the computing unit.

It is also proposed that the converter unit comprises a comparator. This has the advantage of enabling the output signal to be converted into the square wave signal using particularly simple technical means. The comparator advantageously comprises a positive input, a negative input, and an output. The converter unit preferably comprises a pull-up resistor, a pull-down resistor, and a voltage source which are connected to the positive input of the comparator. The voltage source is designed to provide a reference voltage for the comparator, the magnitude of which can be adjusted by the values of the pull-up resistor and the pull-down resistor. The negative input of the comparator is preferably connected to the measurement output of the oscillator circuit via the input of the converter unit. In one operating state of the converter unit, the comparator is designed to output the value of the reference voltage, for example 3.3 V, at its output if a value of an input signal at the negative input is greater than half the reference voltage, and to output a voltage of zero if the value of the input signal at the negative input is below half the reference voltage.

It is also proposed that the converter unit has an input impedance for the comparator that is greater than an input impedance of the oscillator circuit. This can advantageously improve detection efficiency. In particular, the influence of the converter unit on the oscillator circuit and thus on the output signal can be reduced, in particular minimized. Preferably, the converter unit has an input impedance greater than 1 MΩ and the oscillator circuit has an input impedance less than 10Ω.

It is also proposed that the converter unit comprises a high-pass filter. Such a design has the advantage of improving the accuracy with which the frequency of the output signal is determined. Filtering of low frequencies, in particular interference frequencies, can be enabled if the converter unit comprises a high-pass filter. Furthermore, the output signal can be advantageously adapted to the negative input of the comparator using simple technical means. The high-pass filter is preferably arranged between the input of the converter unit and the negative input of the comparator. The high-pass filter can, for example, be designed as an RC high-pass filter and comprise at least one electrical resistor and at least one capacitor.

It is also proposed that the converter unit comprises a resistive voltage divider. This has the advantage of further improving the adaptation of the output signal to the negative input of the comparator. Furthermore, the input impedance of the converter unit for the comparator can be advantageously adapted by particularly simple technical means so that it is greater than an input impedance of the oscillator circuit. The resistive voltage divider has at least two, preferably exactly two, electrical resistors, the values of which are selected such that the input impedance of the converter unit is greater than the input impedance of the oscillator circuit. Preferably, the electrical resistors of the resistive voltage divider are each arranged electrically parallel to the input of the converter unit. Preferably, the electrical resistors of the resistive voltage divider are also part of the high-pass filter of the converter unit.

It is also proposed that the scanning unit comprises a peak value detector unit which is connected to the measurement output of the oscillator circuit and is designed to detect a peak value of the output signal for determining the amplitude. This advantageously enables the amplitude of the output signal of the detection unit to be determined by particularly simple technical means and in a particularly cost-efficient manner. The peak value detector unit comprises an input which is connected to the measurement output of the oscillator circuit. The peak value detector unit preferably comprises an output which is connected to an input of the computing unit. The computing unit preferably comprises an analog-to-digital converter for converting an analog signal of the peak value detector unit into a digital signal. Alternatively, the scanning unit could also comprise an analog-to-digital converter connected to the output of the peak value detector unit and to a digital input of the computing unit. In lieu of a peak value detector unit, the scanning unit could also have an operational amplifier connected to the measurement output of the oscillator circuit and designed to detect the amplitude of the output signal.

It is also proposed that the converter unit and the peak value detector unit be arranged electrically parallel to each other. Such a design has the advantage of further increasing the accuracy of the determination of the frequency and amplitude of the output signal. In particular, mutual interference between the converter unit and the peak value detector unit can be reduced if these are arranged electrically parallel to each other. Alternatively, the input of the peak value detector unit could also be branched off from the converter unit, for example between the voltage divider and the negative input of the comparator.

It is also proposed that the peak value detection unit comprises a comparator. This has the advantage that the peak value of the output signal can be detected using particularly simple technical means to determine the amplitude. The comparator of the peak value detector unit advantageously has a positive input, a negative input, and an output. The peak value detector unit preferably comprises a resistive voltage divider which is arranged between the input of the peak value detector unit and the positive input of the comparator. The resistive voltage divider of the peak value detector unit comprises at least two, preferably exactly two, electrical resistors, wherein one of the electrical resistors is connected to a voltage source of the peak value detector unit. The peak value detector unit advantageously has a high-pass filter which is arranged between the input of the peak value detector unit and the positive input of the comparator and which can be designed, for example, as an RC high-pass filter with at least one capacitor and at least one electrical resistor, wherein the electrical resistors of the resistive voltage divider can additionally be part of the high-pass filter. The voltage divider and the high-pass filter at the positive input of the comparator are provided to adapt the output signal to the positive input of the comparator. The peak value detector unit preferably comprises a diode and a storage capacitor. In one operating state of the peak value detector unit, the comparator is designed to set its output to a value of a reference voltage of the voltage source of the peak value detector unit if a voltage to which the storage capacitor is charged is lower than the voltage at the positive input of the comparator, and to a value of zero if the voltage to which the storage capacitor is charged is greater than the voltage at the positive input.

It is also proposed that the peak value detector unit comprises at least two high-pass filters connected downstream of the comparator. Such a design has the advantage of increasing the reliability of the peak value detector unit. In particular, interference can be reduced if the peak value detector unit comprises at least two high-pass filters connected downstream of the comparator. In addition, electromagnetic compatibility (EMC) can be improved advantageously. Preferably, a first high-pass filter is connected directly downstream of the comparator and directly connected to the output of the comparator. Preferably, a second high-pass filter is connected downstream of the first high-pass filter and arranged close to the output of the peak value detector unit. The high-pass filters connected downstream of the comparator can, for example, be designed as RC high-pass filters and each comprise at least one capacitor and at least one electrical resistor.

The invention also relates to an induction cooktop with an induction cooktop apparatus according to one of the previously described embodiments. Such an induction cooktop is particularly characterized by its advantageous properties in terms of operating convenience, which can be achieved by means of the embodiment in accordance with the invention of the induction cooktop apparatus.

The invention also relates to a method for operating an induction cooktop apparatus, in particular in accordance with one of the previously described embodiments, with at least one heating inductor and at least one detection unit, which has at least one self-oscillating oscillator circuit that is designed to measure properties of an induction load of the heating inductor, and a feedback network, wherein the heating inductor is part of the feedback network, wherein an output signal of the detection unit is scanned at a measurement output of the oscillator circuit.

It is proposed that a frequency and an amplitude of the output signal be determined. This advantageously provides a method for operating the induction cooktop apparatus, which enables particularly high operating convenience.

The induction cooktop apparatus should not be limited to the application and embodiment described above. In particular, the induction cooktop apparatus can have a number of individual elements, components, and units that differs from the number specified herein in order to fulfill a function described herein.

Further advantages are evident from the following description of the drawing. Exemplary embodiments of the invention are illustrated in the drawing. The drawing, the description and the claims contain numerous features in combination. The person skilled in the art will also consider the features individually in an expedient manner and combine said individual features to form expedient further combinations.

In the drawing:

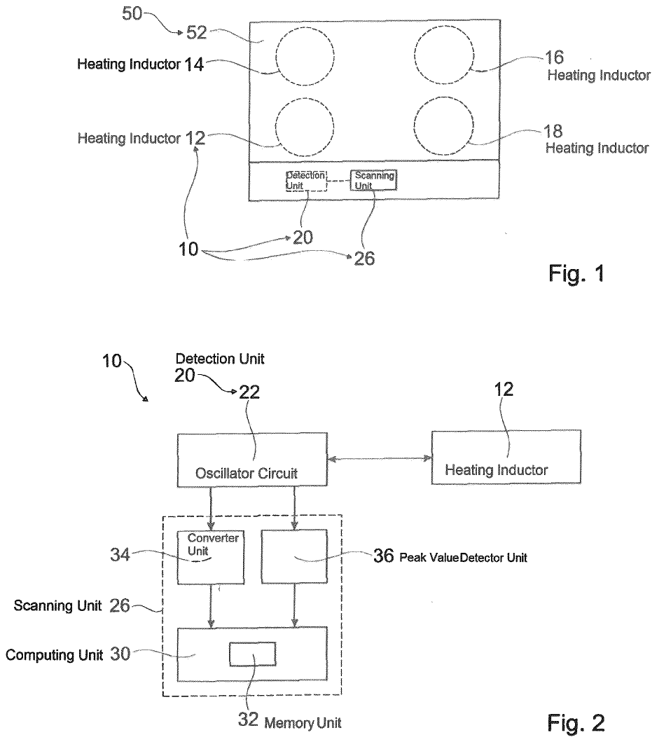

FIG. 1 shows a schematic representation of an induction cooktop with an induction cooktop apparatus, comprising at least one heating inductor,

FIG. 2 shows a schematic block diagram of the induction cooktop apparatus with a detection unit and a scanning unit, which comprises a converter unit, a peak value detector unit, and a computing unit with a memory unit,

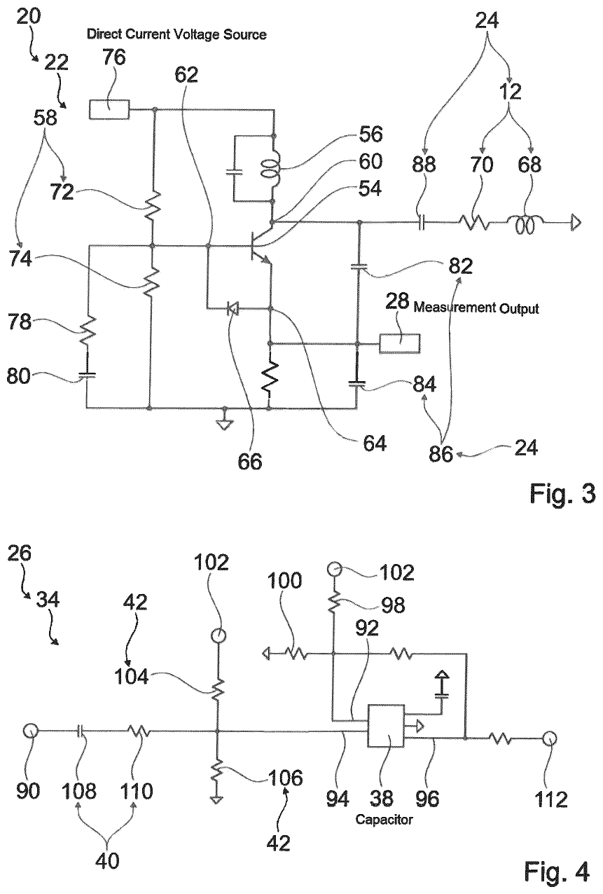

FIG. 3 shows a schematic electrical circuit diagram of a self-oscillating oscillator circuit of the detection unit,

FIG. 4 shows a schematic electrical circuit diagram of the converter unit of the scanning unit,

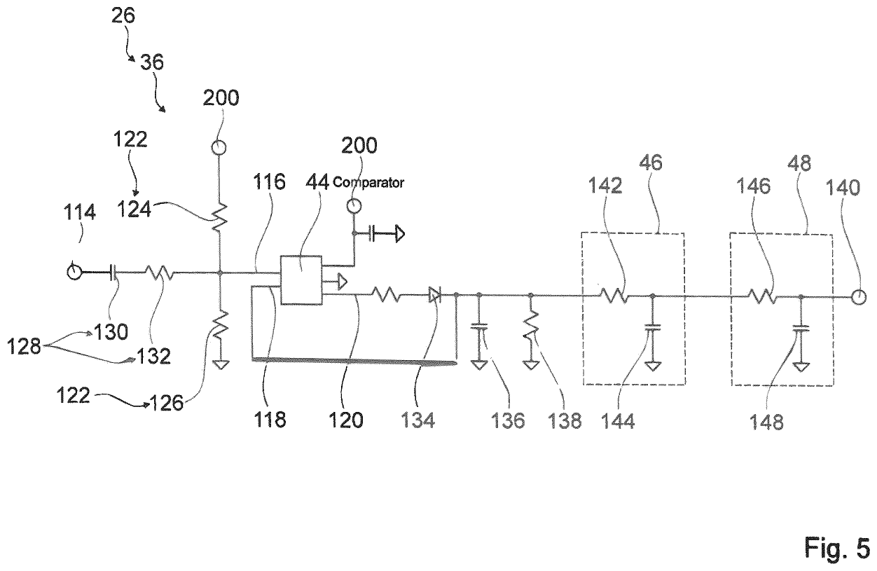

FIG. 5 shows a schematic electrical circuit diagram of the peak value detector unit of the scanning unit,

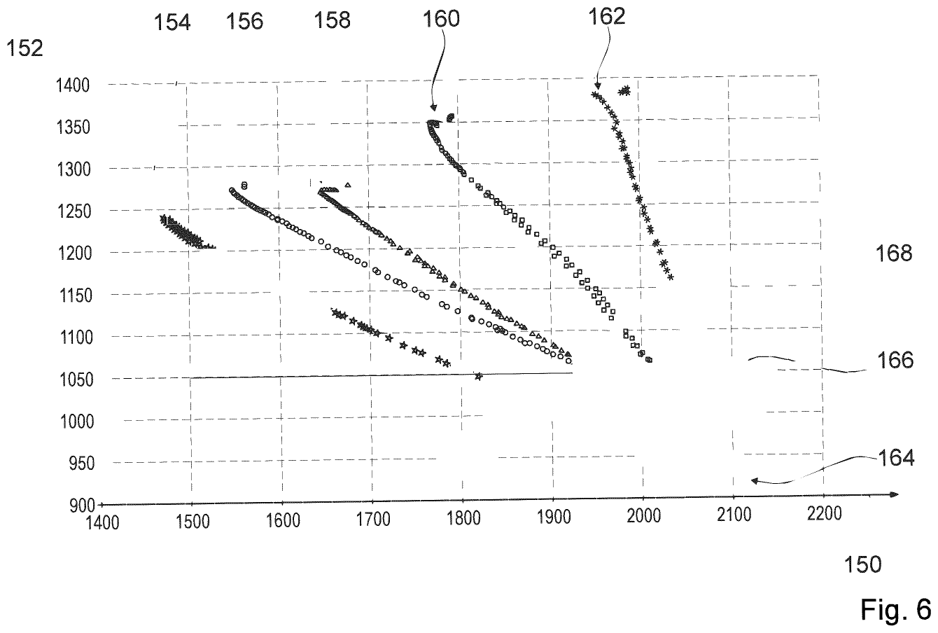

FIG. 6 shows a schematic diagram illustrating reference output signals for different induction loads stored in the memory unit,

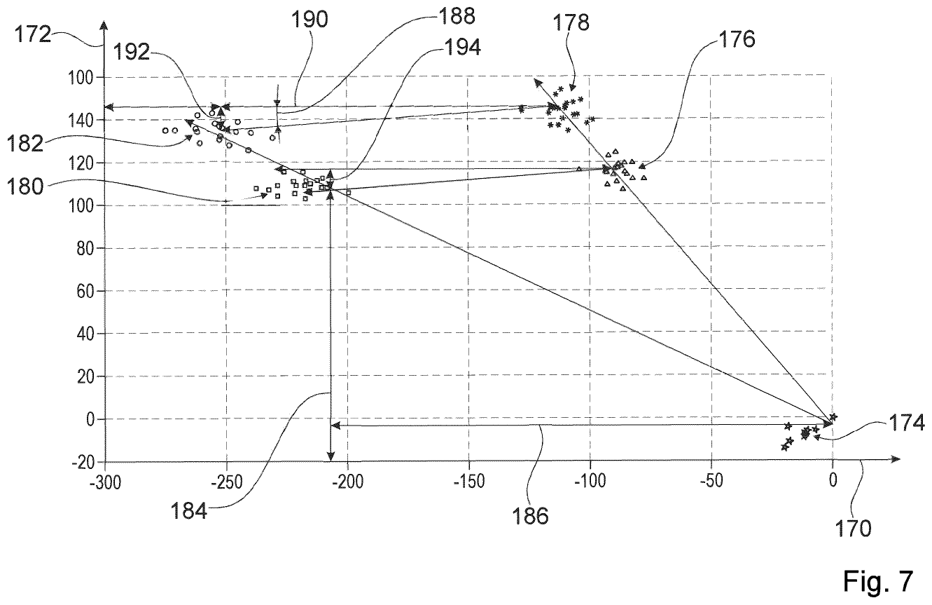

FIG. 7 shows a schematic diagram illustrating an operation of an algorithm by means of which the computing unit evaluates a frequency and an amplitude of an output signal of the detection unit, and

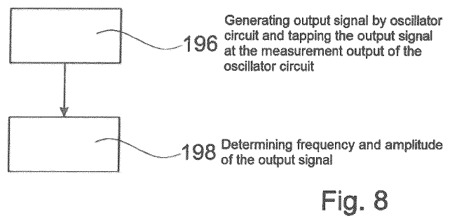

FIG. 8 shows a schematic method flow diagram illustrating a method for operating the induction cooktop apparatus.

FIG. 1 shows an induction cooktop 50 in a schematic representation. The induction cooktop 50 comprises an induction cooktop apparatus 10. The induction cooktop apparatus 10 comprises at least one heating inductor 12. In the present case, the induction cooktop apparatus comprises the heating inductor 12 and three further heating inductors 14, 16, 18. The heating inductors 12, 14, 16, 18 are arranged below a cooktop plate 52 of the induction cooktop 50 and are designed to supply energy in the form of an alternating electromagnetic field to at least one object (not shown), for example an item of cookware, on the cooktop plate 52 in a heating mode. The induction cooktop apparatus 10 is not limited to four heating inductors 12, 14, 16, 18, but could alternatively have any number of heating inductors 12, 14, 16, 18 greater than or equal to one without departing from the scope of the present invention.

The induction cooktop apparatus 10 comprises a detection unit 20. The detection unit 20 has a self-oscillating oscillator circuit 22 (see FIG. 3), which is designed to measure properties of an induction load of the heating inductor 12, and a feedback network 24 (see FIG. 3), wherein the heating inductor 12 is part of the feedback network 24. The self-oscillating oscillator circuit 22 is also provided for measuring properties of induction loads of the further heating inductors 14, 16, 18. The induction cooktop apparatus 10 can comprise a multiplexer circuit (not shown) which is designed to connect the detection unit 20 to the heating inductors 12, 14, 16, 18 in succession for a detection mode and to disconnect the connection between the detection unit 20 and the heating inductors 12, 14, 16, 18 for a heating mode of the heating inductors 12, 14, 16, 18. In the heating mode, the heating inductors 12, 14, 16, 18 are each operated by an inverter unit (not shown) of the induction cooktop apparatus 10.

FIG. 2 shows a schematic block diagram of the induction cooktop apparatus 10 with the heating inductor 12 and the oscillator circuit 22 of the detection unit 20. The induction cooktop apparatus 10 also comprises a scanning unit 26. The scanning unit 26 is provided for scanning an output signal of the detection unit 20 at a measurement output 28 (see FIG. 3) of the oscillator circuit 22. It is proposed that the scanning unit 26 is designed to determine a frequency and an amplitude of the output signal.

The scanning unit 26 comprises in the present case a converter unit 34 which is connected to the measurement output 28 of the oscillator circuit 22 and is designed to convert the output signal into a square wave signal for determining the frequency.

The scanning unit 24 also comprises a peak value detector unit 36 which is connected to the measurement output 28 of the oscillator circuit 22 and is designed to detect a peak value of the output signal for determining the amplitude.

In the present case, the converter unit 34 and the peak value detector unit 36 are arranged electrically parallel to each other.

In the present case, the scanning unit 26 has a computing unit 30. The computing unit 30 is designed to evaluate the frequency and amplitude of the output signal in order to determine the properties of the induction load of the heating inductor 12 by means of at least one algorithm.

The computing unit 30 also has a memory unit 32 in which reference values of frequencies and amplitudes of reference output signals for different induction loads (see FIG. 6) are stored. The computing unit 30 is designed to compare the frequency and amplitude of the output signal with the reference values during evaluation. In the present case, the algorithm is self-learning. In the present case, the computing unit 30 is provided to store frequencies and amplitudes of output signals detected in previous detection processes in the memory unit 32, feed them into the self-learning algorithm, and use them when evaluating a current output signal.

FIG. 3 shows a schematic electrical circuit diagram of the self-oscillating oscillator circuit 22. In the present case, the oscillator circuit 22 comprises a single transistor 54, the feedback network 24, a choke coil 56, and a resistive voltage divider 58.

The transistor 54 has a collector terminal 60, a base terminal 62, and an emitter terminal 64. The transistor 54 is connected in a base circuit. In the present case, the oscillator circuit 22 has a protective diode 66, the anode of which is connected to the emitter terminal 64 and the cathode of which is connected to the base terminal 62 of the transistor 54. The protective diode 66 is therefore connected in the forward direction from the emitter connection 64 toward the base connection 62. The protective diode 66 is provided to protect the transistor 54 against overvoltage

In the electrical circuit diagram of FIG. 3, the heating inductor 12 is represented by its substitute inductor 68 and its substitute electrical resistor 70.

The choke coil 56 is connected to the collector terminal 60 of the transistor 54 and has an inductance which is selected such that the choke coil 56 has a low impedance for direct currents and a high impedance for alternating currents with a frequency in an operating frequency range of the detection unit 20. In the present case, the choke coil 56 has an inductance of 1.0 mH.

The oscillator circuit 22 has two electrical resistors 72, 74 which form the resistive voltage divider 58. The base terminal 62 of the transistor 54 is connected to the resistive voltage divider 58 in order to set a direct current operating point of the transistor 54 to half of a supply voltage of the oscillator circuit 22. The electrical resistors 72, 74 therefore have the same values. In the present case, the induction cooktop apparatus 10 has a direct current voltage source 76 for supplying the supply voltage to the oscillator circuit 22. The transistor 54 is connected to the direct current voltage source 76 via its collector terminal 60 and via the choke coil 56. The transistor 54 is also connected to its base terminal 62 via the resistive voltage divider 58 with the direct current voltage source 76.

The oscillator circuit 22 has an electrical resistor 78 and a capacitor 80, each of which is electrically connected in series to the base terminal 62 of the transistor 54. The electrical resistor 78 and the capacitor 80 are designed to set a base impedance during an alternating current operation in order to ensure oscillation for a wide range of induction loads. The electrical resistor 78, which is electrically connected in series to the base terminal 62 of the transistor 54, has a value which is at least a factor of 2 smaller than the values of the electrical resistors 72, 74 which form the resistive voltage divider 58. The electrical resistor 78, which is electrically connected in series to the base terminal 62 of the transistor 54, has a value of at least 40Ω and at most 250Ω. In the present case, the electrical resistor 78 has a value of 200Ω. The electrical resistors 72, 74 each have a value of 1 kΩ, so that the value of the electrical resistor 78 is a factor of five smaller than the values of the electrical resistors 72, 74.

The capacitor 80, which is electrically connected in series to the base connection 62 of the transistor 54, has a capacitance of 100 nF. For direct current, the capacitor 80 therefore has a high impedance, so that the direct current operating point of the transistor 54 is set solely by the resistive voltage divider 58. For alternating currents with a frequency in the operating frequency range of the detection unit 20, however, the capacitor 80 forms a short-circuit path, so that the base impedance of the transistor 54 is determined by the electrical resistor 78 during an alternating current operation.

The oscillator circuit 22 has two capacitors 82, 84, which are arranged between the collector terminal 60 and the emitter terminal 64 of the transistor 54 and form a capacitive voltage divider 86. In the present case, the capacitors 82, 84 are part of the feedback network 24. The measurement output 28 of the oscillator circuit 22 is arranged between the capacitor 82 and the capacitor 84. This arrangement of the measurement output 28 filters out low-frequency noise. The capacitances of the capacitors 82, 84 are selected such that the amplitude condition according to the stability criteria of Barkhausen and Nyquist, which are known to those skilled in the art, are fulfilled. Since the transistor 54 is connected in a base circuit and the base as a common reference point causes a phase shift of 0°, the feedback network 24 also causes a phase shift of 0°, so that the phase condition is also fulfilled in accordance with the stability criteria of Barkhausen and Nyquist.

The oscillator circuit 22 also has a further capacitor 88, which is electrically connected in series to the collector terminal 60 of the transistor 54 and which, at least in detection mode, is electrically connected in series to the heating inductor 12. In the present case, the oscillator circuit 22 is therefore a variant of a Clapp oscillator. The oscillation frequency of the oscillator circuit 22 is determined in the present case by the further capacitor 88. The further capacitor 88 has a capacitance which is at least a factor of 10 smaller than the capacitances of the capacitors 82, 84 which form the capacitive voltage divider 86.

The present invention is not limited to the design of the oscillator circuit 22 shown in FIG. 3, and alternatively other oscillator circuits (not shown), which could be designed, for example, as a Colpitts oscillator or the like, could also be used without departing from the scope of the present invention.

FIG. 4 shows a schematic electrical circuit diagram of the converter unit 34 of the scanning unit 26 of the induction cooktop apparatus 10. The converter unit 34 has an input 90 connected to the measurement output 28 of the oscillator circuit 22 (see FIG. 3). The converter unit 34 comprises a comparator 38. The comparator 38 has a positive input 92, a negative input 94, and an output 96. The converter unit 34 has a pull-up resistor 98, a pull-down resistor 100, and a voltage source 102 which are connected to the positive input 92. The voltage source 102 supplies a reference voltage which is set by the values of the pull-up resistor 98 and the pull-down resistor 100. In one operating state of the converter unit 34, the comparator 38 generates a binary value of 1 at the output 96, which corresponds in the present case to a value of the reference voltage of 3.3 V, if a value of an input signal at the negative input 94 is greater than 1.65V, and a binary value of 0 if the value of the input signal at the negative input 94 is below 1.65 V.

The converter unit 34 comprises a resistive voltage divider 42. The resistive voltage divider 42 is arranged between the input 90 of the converter unit 34 and the negative input 94 of the comparator. 38. The resistive voltage divider 42 comprises two electrical resistors 104, 106. The electrical resistor 104 is connected to the voltage source 102 and the values of the electrical resistors 104, 106 are selected such that the input signal is set to the value of the reference voltage.

The converter unit 34 comprises a high-pass filter 40. The high-pass filter 40 is formed by a capacitor 108, an electrical resistor 110 and by the electrical resistors 104, 106. The converter unit 34 has an input impedance for the comparator 39 that is greater than an input impedance of the oscillator circuit 22. The input impedance of the converter unit 34 for the comparator 38 is defined by the values of the electrical resistors 104, 106, 110. In the present case, the converter unit 34 has an input impedance for the comparator 38 greater than 1 M Ω and the oscillator circuit 22 has an input impedance less than 10Ω.

The converter unit 34 has a digital output 112. The converter unit 34 is connected to the computing unit 30 via the digital output 112 (see FIG. 2). The computing unit 30 can be embodied as a microcontroller, for example. A signal at the digital output 112 can, for example, be read in by an input capture pin of the computing unit 30 designed as a microcontroller. The computing unit 30 is designed to determine the number of edges of the signal at the digital output 112 during a time interval. In order to determine the frequency of the output signal of the detection unit 20, the computing unit 30 can use the following formula (1):

$$f = \frac{n}{T} \qquad ( 1 )$$

where f stands for the frequency of the output signal, n stands for the number of edges of the signal at the digital output 112 during the time interval, and T stands for the duration of the time interval.

FIG. 5 shows a schematic electrical circuit diagram of the peak value detector unit 36 of the scanning unit 26, The peak value detector unit 36 has an input 114 which is connected to the measurement output 28 of the oscillator circuit 22 (see FIG. 3). The peak value detector unit 36 comprises a comparator 44. The comparator 44 advantageously has a positive input 116, a negative input 118, and an output 120. The peak value detector unit 36 comprises a resistive voltage divider 122. The resistive voltage divider 122 is arranged between the input 114 of the converter unit 36 and the positive input 116 of the comparator. 44. The resistive voltage divider 122 comprises two electrical resistors 124, 126. The electrical resistor 124 is connected to a voltage source 200 of the peak value detector unit 36. The peak value detector unit 36 has a high-pass filter 128. The high-pass filter 128 is formed by a capacitor 130, an electrical resistor 132 and by the electrical resistors 124, 126. The voltage divider 122 and the high-pass filter 128 are provided to adapt the output signal to the positive input 116 of the comparator 44.

The peak value detector unit 36 comprises a diode 134 and a storage capacitor 136. The comparator 44 is designed to set the output 120 to a value of a reference voltage of the voltage source 200, which in the present case corresponds to 3.3 V, if the voltage at the storage capacitor 136 is lower than the voltage at the positive input 116, and to a voltage of 0 V if the voltage at the storage capacitor 136 is greater than at the positive input 116. If the voltage at the storage capacitor 136 is greater than at the positive input 116, no current can flow due to the diode 134. In order to reset the peak value detector unit 36, the output voltage of the comparator 44 can be set to 0 V and the voltage of the storage capacitor 136 can be discharged via an electrical resistor 138.

The peak value detector unit 36 has an output 140. The peak value detector unit 36 is connected to the computing unit 30 via the output 140 (see FIG. 2). The computing unit 30 comprises an analog-to-digital converter (not shown) in order to convert the peak value of the output signal of the detector unit 20, which is detected by the peak value detector unit 36 and is present at the output 140 in the form of an analog signal, into a digital signal and to determine the amplitude of the output signal therefrom.

In addition to the high-pass filter 128, the peak value detector unit 36 also comprises at least two high-pass filters 46, 48, which are connected downstream of the comparator 44. One high-pass filter 46 is connected directly downstream of the output 120 and comprises an electrical resistor 142 and a capacitor 144 electrically connected parallel thereto. A further high-pass filter 48 is connected downstream of the high-pass filter 46 and upstream of the digital output 140. The further high-pass filter 46 comprises an electrical resistor 146 and a capacitor 148 electrically connected parallel thereto.

FIG. 6 shows a schematic diagram illustrating reference output signals for different induction loads stored in the memory unit 32 of the computing unit 30 (see FIG. 2). An electric current in milliamperes is plotted on an abscissa 150 of the diagram. A frequency in kilohertz is plotted on an ordinate 152 of the diagram. The diagram shows five measurement series 154, 156, 158, 160, 162, wherein a different item of cookware with an identical diameter but made of a different material was used for each of the measurement series 154, 156, 158, 160, 162. All measurement series 154, 156, 158, 160, 162 start at the same starting point 164. The starting point 164 represents a degree of coverage of 0% between the respective item of cookware and the heating inductor 12 (see FIG. 1). As the degree of coverage increases, the frequency of the output signal at measurement output 28 of the oscillator circuit 22 (see FIG. 3) increases and the amplitude of the output signal decreases until each of the measurement series 154, 156, 158, 160, 162 reaches a maximum value corresponding to a degree of coverage of 100%. However, the measurement series 154, 156, 158, 160, 162 have different slopes, which is due to the different materials of the items of cookware used. The measurement series 154 and 156 were carried out with items of cookware made of materials that have low electrical resistance. The measurement series 158 was carried out with an item of cookware made of a material that has medium electrical resistance. The measurement series 160 and 162 were carried out with items of cookware made of materials that have high electrical resistance. The measurement series 162 was carried out with an item of cookware made of aluminum that is not suitable for cooking on the induction cooktop 50 (see FIG. 1). A straight line 166 shows an example of a constant threshold value that can be used with conventional induction cooktops to determine a sufficient degree of coverage. A curve 168 shows a dynamic threshold value that takes into account the different material properties of the items of cookware used. As can be seen in the measurement series 154, 156, 158, 160, 162, not all items of cookware have the same degree of coverage if the constant threshold value is reached. For example, for the item of cookware in the measurement series 154, a sufficient degree of coverage would already be achieved before the constant threshold value is reached, whereas for the items of cookware in the measurement series 160, 162, a degree of coverage required for efficient heating would not yet be achieved if the constant threshold value is exceeded. Since the scanning unit 26 is designed to determine not only the frequency but also the amplitude of the output signal, the computing unit 30 can be designed to determine the material of an item of cookware used on the basis of the frequency and amplitude of the output signal determined by the scanning unit 26 and taking into account the reference values stored in the memory unit 32. The computing unit 30 can also be designed to use a dynamic threshold value for the degree of coverage, which takes into account the material properties of the item of cookware used.

FIG. 7 shows a schematic diagram illustrating the operation of the computing unit, namely the operation of an algorithm which the computing unit 30 can use when evaluating the frequency and amplitude of the output signal in order to determine the properties of the induction load of the heating inductor 12. The algorithm is intended for standardizing the size of an item of cookware, since the output signal can have different frequencies depending on the material of the item of cookware, even if the diameter of the item of cookware is the same. A difference in an electric current in milliamperes is plotted on an abscissa 170 of the diagram. A difference in frequency in kilohertz is plotted on an ordinate axis 172 of the diagram. A measurement series 174 in the diagram shows measurement values for an empty state, i.e. for a degree of coverage of 0% between an item of cookware and the heating inductor 12. A measurement series 176 in the diagram shows measurement values for a disk made of aluminum with a diameter of 80 millimeters at a degree of coverage of 100%. A measurement series 178 in the diagram shows measurement values for a disk made of aluminum with a diameter of 90 millimeters at a degree of coverage of 100%. A measurement series 180 in the diagram shows measurement values for a disk made of C45 with a diameter of 80 millimeters at a degree of coverage of 100%. C45 is an unalloyed steel characterized by a very uniform material structure and is used as a reference material in the field of induction cooktops. A measurement series 182 in the diagram shows measurement values for a disk made of C45 with a diameter of 90 millimeters at a degree of coverage of 100%. The mean values from measurement series 174, 176, 178, 180, 182 are stored in the memory unit 32 of the computing unit 30. A distance 184 in the diagram shows a difference in the frequency between the mean value of the measurement series 180 and a frequency of a currently determined output signal of the detection unit 20 at the measurement output 28 of the oscillator circuit 22. A distance 186 in the diagram shows the difference in the amplitude of the currently determined output signal relative to the mean value of the measurement series 174. A distance 190 shows a difference between the amplitudes of the mean values of the measurement series 178 and the measurement series 182. A distance 192 shows a difference between the frequencies of the mean values of the measurement series 178 and the measurement series 182. A distance 194 shows a difference between the frequencies of the mean values of the measurement series 180 and the measurement series 176. An angle 188 is plotted between the mean values of measurement series 178 and measurement series 182.

The algorithm used by the computing unit 30 to normalize the size of the item of cookware comprises the following formulas (2) to (4):

$$tan β = \frac{Δ Freq}{Δ volt} \qquad ( 2 )$$

$$Δ f = \frac{freq ⋆ tan β ⋆ {alu}_{freq} − tan β ⋆ volt ⋆ {alu}_{volt}}{a l {u}_{freq} + tan β ⋆ {alu}_{volt}} \qquad ( 3 )$$

$${f}_{final} = freq + Δ f \qquad ( 4 )$$

wherein β stands for the angle 188, ΔFreq stands for the distance 192, Δvolt stands for the distance 190, Δf stands for a frequency difference, freq stands for the frequency of the currently determined output signal, alufreq stands for the frequency of the mean value of the measurement series 178, volt stands for the amplitude of the currently determined output signal, aluᵥₒᵢₜ stands for the amplitude of the mean value of the measurement series 178, and f_{final} stands for a corrected frequency of the output signal. The computing unit 30 is provided to use the corrected frequency to determine a diameter of a currently used item of cookware.

FIG. 8 shows a schematic method flow diagram illustrating a method for operating the induction cooktop apparatus 10. In the method, an output signal of the detection unit 20 is scanned at the measurement output 28 of the oscillator circuit 22, and a frequency and an amplitude of the output signal are determined. The method comprises at least two method steps 196, 198. In a first method step 196 of the method, the output signal is generated by the oscillator circuit 22 and tapped at the measurement output 28 of the oscillator circuit 22, namely by the scanning unit 26. In a second method step 198 of the method, the frequency and amplitude of the output signal are determined, namely by the computing unit 30. For this purpose, the output signal is converted into a square wave signal by the converter unit 34 and fed to the computing unit 30. At the same time, the peak value of the output signal is detected by the peak value detector unit 36 and the amplitude of the output signal is determined from this. The method can also include further method steps (not shown) in which an evaluation of the frequency and amplitude can be performed, in particular by the computing unit 30.

### REFERENCE CHARACTERS

10 Induction cooktop apparatus
12 Heating inductor
14 Further heating inductor
16 Further heating inductor
18 Further heating inductor
20 Detection unit
22 Oscillator circuit
24 Feedback network
26 Scanning unit
28 Measurement output
30 Computing unit
32 Memory unit
34 Converter unit
36 Peak value detector unit
38 Comparator
40 High-pass filter
42 Resistive voltage divider
44 Comparator
46 High-pass filter
48 Further high-pass filter
50 Induction cooktop
52 Cooktop plate
54 Transistor
56 Choke coil
58 Resistive voltage divider
60 Collector terminal
62 Base terminal
64 Emitter terminal
66 Protective diode
68 Substitute inductor
70 Substitute resistor
72 Electrical resistor
74 Electrical resistor
76 Direct current voltage source
78 Electrical resistor
80 Capacitor
82 Capacitor
84 Capacitor
86 Capacitive voltage divider
88 Further capacitor
90 Input
92 Positive input
94 Negative input
96 Output
98 Pull-up resistor
100 Pull-down resistor
102 Voltage source
104 Electrical resistor
106 Electrical resistor
108 Capacitor
110 Electrical resistor
112 Digital output
114 Input
116 Positive input
118 Negative input
120 Output
122 Resistive voltage divider
124 Electrical resistor
126 Electrical resistor
128 High-pass filter
130 Capacitor
132 Electrical resistor
134 Diode
136 Storage capacitor
138 Electrical resistor
140 Output
142 Electrical resistor
144 Capacitor
146 Electrical resistor
148 Capacitor
150 Abscissa
152 Ordinate
154 Measurement series
156 Measurement series
158 Measurement series
160 Measurement series
162 Measurement series
164 Starting point
166 Straight line
168 Curve
170 Abscissa
172 Ordinate
174 Measurement series
176 Measurement series
178 Measurement series
180 Measurement series
182 Measurement series
184 Distance
186 Distance
188 Angle
190 Distance
192 Distance
194 Distance
196 First method step
198 Second method step
200 Voltage source

1-15. (canceled)

16. An induction cooktop apparatus, comprising:
a heating inductor;
a detection unit comprising a self-oscillating oscillator circuit designed to measure a property of an induction load of the heating inductor, and a feedback network designed such that the heating inductor is part of the feedback network; and
a scanning unit designed to scan an output signal of the detection unit at a measurement output of the oscillator circuit, said scanning unit designed to determine a frequency and an amplitude of the output signal.

17. The induction cooktop apparatus of claim 16, wherein the scanning unit comprises a computing unit designed to evaluate the frequency and amplitude of the output signal in order to determine the property of the induction load of the heating inductor by an algorithm.

18. The induction cooktop apparatus of claim 17, wherein the computing unit comprises a memory unit designed to store reference values of frequencies and amplitudes of reference output signals for different induction loads, said computing unit designed to compare the frequency and amplitude of the output signal with the reference values during evaluation.

19. The induction cooktop apparatus of claim 17, wherein the algorithm is self-learning.

20. The induction cooktop apparatus of claim 16, wherein the scanning unit comprises a converter unit connected to the measurement output of the oscillator circuit and designed to convert the output signal into a square wave signal for determining the frequency.

21. The induction cooktop apparatus of claim 20, wherein the converter unit comprises a comparator.

22. The induction cooktop apparatus of claim 21, wherein the converter unit has an input impedance for the comparator, with the input impedance for the comparator being greater than an input impedance of the oscillator circuit.

23. The induction cooktop apparatus of claim 20, wherein the converter unit comprises a high-pass filter.

24. The induction cooktop apparatus of claim 20, wherein the converter unit comprises a resistive voltage divider.

25. The induction cooktop apparatus of claim 16, wherein the scanning unit comprises a peak value detector unit connected to the measurement output of the oscillator circuit and designed to detect a peak value of the output signal for determining the amplitude.

26. The induction cooktop apparatus of claim 25, wherein the scanning unit comprises a converter unit connected to the measurement output of the oscillator circuit and designed to convert the output signal into a square wave signal for determining the frequency, wherein the converter unit and the peak value detector unit are arranged electrically parallel to one another.

27. The induction cooktop apparatus of claim 25, wherein the peak value detector unit comprises a comparator.

28. The induction cooktop apparatus of claim 27, wherein the peak value detector unit comprises at least two high-pass filters which are connected downstream of the comparator.

29. An induction cooktop, comprising the induction cooktop apparatus of claim 16.

30. A method for operating an induction cooktop apparatus which comprises a heating inductor and a detection unit which comprises a self-oscillating oscillator circuit designed to measure a property of an induction load of the heating inductor, and a feedback network designed such that the heating inductor is part of the feedback network, the method comprising:
scanning an output signal of the detection unit at a measurement output of the oscillator circuit; and
determining a frequency and an amplitude of the output signal.

31. The method of claim 30, further comprising evaluating the frequency and amplitude of the output signal in order to determine a property of the induction load of the heating inductor by an algorithm.

32. The method of claim 31, further comprising:
storing reference values of frequencies and amplitudes of reference output signals for different induction loads; and
comparing the frequency and amplitude of the output signal with the reference values during evaluation.

33. The method of claim 30, further comprising converting the output signal into a square wave signal for determining the frequency.

34. The method of claim 30, further comprising detecting a peak value of the output signal for determining the amplitude.
